(19) United States
(12) Patent Application Publication
(10) Pub. No.: US 2019/0287009 A1
(43) Pub. Date: Sep. 19, 2019

(54) METHOD FOR CONTROLLING SCENE DETECTION USING AN APPARATUS

(71) Applicant: STMicroelectronics (Rousset) SAS, Rousset (FR)

(72) Inventors: Laurent Folliot, Gourdon (FR); Pierre Demaj, Nice (FR)

(21) Appl. No.: 16/286,133

(22) Filed: Feb. 26, 2019

(30) Foreign Application Priority Data
Mar. 19, 2018 (FR) 1852333

(51) Int. Cl. G06N 5/04; G06N 20/00

(52) U.S. Cl. CPC G06N 5/048; G06N 20/00

(57) ABSTRACT

An embodiment provides a method for controlling scene detection by a device from among a set of possible reference scenes. The method includes detection of scenes from among the set of possible reference scenes at successive instants of detection using at least one classification algorithm. Each new current detected scene is assigned an initial probability of confidence. The initial probability of confidence is updated depending on a first probability of transition from a previously detected scene to the new current detected scene. A filtering processing operation is performed on these current detected scenes on the basis of at least the updated probability of confidence associated with each new current detected scene. The output of the filtering processing operation successively delivers filtered detected scenes.

### CROSS-REFERENCE TO RELATED APPLICATIONS

This application claims priority to French Patent Application No. 1852333, filed on Mar. 19, 2018, which application is hereby incorporated herein by reference.

### TECHNICAL FIELD

Embodiments provide a method for controlling scene detection by an apparatus.

### BACKGROUND

A scene is understood, in a very broad sense, to incorporate in particular a scene characteristic of the environment in which the device is located, whether the device is carried by a user who is likely to move, for example, a cellular mobile telephone (a ‘bus’, ‘train’, ‘restaurant’, ‘office’, etc. scene) or the device is a connected or non-connected fixed object (a radiator in a home automation application, for example), the scene characteristic of the environment being able to be, for example, of ‘wet part’, ‘dry part’, ‘day’, ‘night’ ‘shutters closed’, ‘shutters open’, etc. type.

A scene may also incorporate a scene characteristic of an activity performed by the carrier of the device, for example, a smart watch, such a scene then being able to be ‘walking’, ‘running’, etc.

Some wireless communication devices, such as, for example, certain types of smartphone or tablet, are nowadays capable of carrying out scene detections, thereby making it possible to determine the environment in which the user of the telephone or of the tablet is situated. This may thus allow a third party, for example, an advertiser or a cultural body, for example, to send relevant information relating to the location at which the user of the device is situated.

Thus, for example, if the user is situated at a given tourism site, it is thus possible to send to him restaurant addresses in the vicinity of the area where he is located. Likewise, it is also possible to send to him information relating to certain monuments that are situated in the vicinity of the area where he is located.

‘Scene detection’ is understood to mean in particular a discrimination of the scene in which the wireless communication device is located. Several known solutions exist for detecting (discriminating) a scene. These solutions use, for example, one or more dedicated sensors that are generally associated with a specific algorithm.

Among the specific algorithms, mention may be made of classifiers or decision trees, which are well known to those skilled in the art in scene detection. Mention may be made in particular of a neural network algorithm that is known to those skilled in the art and for which reference may be made, for example, for all useful purposes, to the work by Martin T Hagan and Howard B Demuth entitled Neural Network Design (2nd Edition), 1 Sep. 2014, or else an algorithm known to those skilled in the art under the name GMM (‘Gaussian Mixture Model’), those skilled in the art being able to refer, for example, for all useful purposes, to the tutorial slides by Andrew Moore entitled ‘Clustering with Gaussian Mixtures’, available on the website https://www.autonlab.org/tutorials/gmm.html.

These two algorithms are also configured to deliver a probability of confidence for each detected scene.

Mention may also be made, as a classification algorithm, of a meta-classification algorithm or ‘meta-classifier’, that is to say an algorithm that is situated on a layer higher than that containing a plurality of classification algorithms.

Each classification algorithm provides a decision with regard to a detected scene, and the meta-classifier compiles the decisions provided by the various classification algorithms in order to deliver a final decision, for example, by way of a majority vote or of an average.

Meta-classifiers perform better than conventional classifiers, but nevertheless are still subject to possible detection errors. Furthermore, they are more complicated to implement, in particular in terms of memory size, and require more complex learning phases.

### SUMMARY

Modes of implementation and embodiments of the invention relate to the real-time detection of a scene by a device, in particular, but not exclusively, a wireless communication device, for example, a smartphone or else a digital tablet, equipped with at least one sensor, such as, for example, an accelerometer, and more particularly to the improvement of the reliability of the decisions provided by a classification algorithm before filtering thereof.

Embodiments of the invention can further improve the reliability of the decisions provided by a classification algorithm, regardless of the type thereof, and to achieve this in a way that is easy to implement.

For example, one embodiment provides a method for controlling scene detection by a device from among a set of possible reference scenes. The method comprises detection of scenes from among the set of possible reference scenes at successive instants of detection using at least one classification algorithm. Each new current detected scene is assigned an initial probability of confidence. The initial probability of confidence is updated depending on a first probability of transition from a previously detected scene to the new current detected scene. A filtering processing operation is performed on these current detected scenes on the basis of at least the updated probability of confidence associated with each new current detected scene. The output of the filtering processing operation successively delivers filtered detected scenes.

### BRIEF DESCRIPTION OF THE DRAWINGS

Other advantages and features of the invention will become apparent on examining the detailed description of wholly non-limiting modes of implementation and embodiments and the appended drawings, in which:

FIGS. 1 to 5 schematically illustrate various modes of implementation and embodiments of the invention.

### DETAILED DESCRIPTION OF ILLUSTRATIVE EMBODIMENTS

The inventors have observed that certain transitions between a first scene and a second scene are unlikely, or even impossible, for the user of the device.

According to one mode of implementation and embodiment, it is proposed to utilize the user's habits, and more particularly probabilities of transition between the successively detected scenes, for the purpose of improving scene detection.

According to one aspect, what is proposed is a method for controlling scene detection by a device from among a set of possible reference scenes.

Embodiments provide a method that comprises detection of scenes from among the set of possible reference scenes at successive instants of detection using at least one classification algorithm. Each new current detected scene being assigned an initial probability of confidence. The method also includes updating of the initial probability of confidence depending on a first probability of transition from a previously detected scene to the new current detected scene, and a filtering processing operation on these current detected scenes on the basis of at least the probability of confidence associated with each new current detected scene, the output of the filtering processing operation successively delivering filtered detected scenes.

User experience is advantageously a parameter to be taken into consideration in scene detection. Specifically, the first probability of transition makes it possible to quantify the probability of the user transitioning from one scene to another.

Certain transitions from one scene to another are unlikely, or even impossible.

Thus, by taking this parameter into account, the initial probability of confidence associated with the current detected scene is improved.

Also, during the filtering processing operation, for example, a meta-filter, the updated probability of confidence associated with the new current detected scene makes it possible to reduce or even to eliminate the noise disturbing the meta-filter before any other decision, thereby giving the meta-filter better performance.

According to one mode of implementation, the updating of the probability of confidence associated with the new current detected scene may comprise multiplication of the initial probability of confidence by the first probability of transition.

In other words, the initial probability of confidence associated with the new current detected scene is weighted by the first probability of transition.

According to one mode of implementation, the method furthermore comprises normalization of the updated probability of confidence associated with the new current detected scene.

According to one mode of implementation, each transition from a first scene from among the set of possible reference scenes to a second scene from among the set of possible reference scenes is assigned a first probability of transition having an arbitrary or updated value.

It is preferable to update the first probability of transition, and to do this over the entire life of the user's device. This makes it possible to adapt to the changes in experience of the user who owns the device.

According to one mode of implementation, the first probability of transition is updated if, during a given time interval, at least one transition from the first to the second scene is performed, and this updating comprises calculation of a second probability of transition for each transition from the first scene to each of the possible second scenes from among the set of possible reference scenes.

‘Given time interval’ is understood to mean, for example, a period corresponding to N transitions observed, for example, over a non-sliding window.

The number N is, for example, defined depending on the corpus of the reference scenes.

This may be carried out, for example, by a counter that counts the transitions up to N transitions.

According to one mode of implementation, the updating of the first probability of transition may comprise increasing the value thereof by a first set value if the second probability of transition is higher than the first probability of transition.

The first set value may be, for example, between 0.01 and 0.05.

According to one mode of implementation, the updating of the first probability of transition comprises reducing the value thereof by a second set value if the second probability of transition is lower than the first probability of transition.

The second set value may be, for example, between 0.01 and 0.05.

According to one mode of implementation, each first probability of transition liable to be updated is updated using a differentiable optimization algorithm.

The classification algorithm may deliver the initial probability of confidence associated with the new current detected scene.

If the classification algorithm does not deliver the initial probability of confidence associated with the new current detected scene, it is then possible to assign the new current detected scene a probability of confidence having an arbitrary value.

If the value of the initial probability of confidence is not available, it is considered to have a value set at 100%. In this case, the weighting by the first probability of transition is performed on the probability having the value set at 100%.

The processing operation of updating the initial probabilities of confidence is compatible with any type of classification algorithm, but also with any type of filtering processing operation performed on the basis of probabilities associated with the detected scenes by the classification algorithm.

This processing operation of updating the initial probabilities of confidence is in particular compatible, when there is provision to assign an identifier to each reference scene, with a filtering processing operation on the current detected scenes carried out not only on the basis of the updated probability of confidence associated with each new current detected scene, but also on the basis of the identifier of each new current detected scene. (Each detected scene effectively has an identifier, since each detected scene is one of the reference scenes that each has an identifier.)

A filtering processing operation of this type is described, for example, in the French patent application filed May 10, 2017 under no. 1754080 (counterpart U.S. application Ser. No. 15/924,608, filed Mar. 19, 2018). A ‘meta-filter’ that makes it possible to utilize the temporal correlation between two consecutive decisions has therefore been proposed in the French patent application. The meta-filter acts on successive decisions that are delivered by the classification algorithm, regardless of the type thereof and including a meta-classifier. These applications are incorporated herein by reference.

Some Features Thereof Will be Recalled Here.

The filtering processing operation is a sliding temporal filtering processing operation on these current detected scenes over a filtering window of size M, on the basis of the identifier of each new current detected scene taken into account in the window and of the updated probability of confidence associated with this new current detected scene.

The value of M defines the size of the filter and its latency (of the order of M/2) and contributes to its accuracy. A person skilled in the art will know how to determine this value depending on the targeted application and on the desired performance.

That being said, a value of 15 for M may be a good compromise.

This filtering processing operation is compatible with any type of classification algorithm.

For a classification algorithm that is configured to deliver, at each instant of detection, a single detected scene, provision may be made for a register, for example, a shift register, of size M (1×M) in order to form the window of size M.

Thus, in particular, there may be provision for a storage circuit including a shift register of size M forming the window of size M, and, for each new current detected scene, its identifier and the associated updated probability of confidence, which is possibly normalized, is stored in the register, the filtering processing operation is carried out using the M identifiers that are present in the register and their associated updated probability of confidence, which is possibly normalized, and one of the possible scenes, that is to say one of the reference scenes, is delivered as filtered detected scene.

When the content of the register is shifted at each new current detected scene, the identifier that is extracted therefrom is the oldest identifier in terms of time. Of course, however, the identifier that will be delivered after filtering may be any identifier from the register, for example, that of the scene that has just been detected or else that of a preceding scene.

That being said, the classification algorithm may be configured to deliver, at each instant of detection, a group of several scenes. This is the case for example, for a meta-classifier in which use will be made, at each instant of detection, of the various detected scenes by the various decision trees that make up the meta-classifier, without using the final step of the majority vote, for example.

This may also be the case for a neural network that uses the various scenes and their corresponding probability of confidence that are respectively associated with the various neurons of the output layer.

In the case of a classification algorithm (for example, a meta-classifier or a neural network) configured to deliver, at each instant of detection, a group of D scenes, where D is greater than 1, it is possible to provide, in order to form the filtering window of size M, a memory of larger size that is capable of storing a matrix of size D×M (D being the number of rows and M the number of columns).

It is then possible to store, in the storage circuit forming the window of size M, for each new group of D current detected scenes, the updated probabilities of confidence, which are possibly normalized, associated with the identifiers of these D current detected scenes, the filtering processing operation is carried out using the D×M identifiers and their associated updated probability of confidence, which is possibly normalized, and one of the possible scenes, that is to say one of the reference scenes, is delivered as filtered detected scene.

The filtering processing operation may comprise, in particular when the storage circuit comprises a shift register of size M, definition of an integer J greater than or equal to two and less than or equal to the whole part of M/2, and, for each identifier present in the register framed by 2J identical identifiers. The filtering processing operation may also comprise comparison of this framed identifier with the 2J framing identifiers, and, in the event of non-identity of values, replacement of the framed identifier with one of the framing identifiers, and assignment, to the framing identifier replacing the framed identifier, of an updated probability of confidence, which is possibly normalized, calculated on the basis of the updated probabilities of confidence, which are possibly normalized, of the 2J framing identifiers, for example, the average of the probabilities of confidence, which are possibly normalized, of the 2J framing identifiers.

This makes it possible for example, to eliminate isolated detection errors.

When the storage circuit is suited to a classification algorithm that is configured to successively deliver groups of D detected scenes, the filtering processing operation that has just been outlined above in particular to eliminate isolated errors is then advantageously applied to the matrix D×M, row by row.

According to one mode of implementation that is compatible regardless of the configuration of the classification algorithm and therefore regardless of the size of the storage circuit, the filtering processing operation comprises, for each identifier taken into account more than once in the storage circuit, summing of the updated probabilities of confidence, which are possibly normalized, that are associated therewith, the filtered detected scene then being the one whose identifier taken into account in the storage circuit has the highest total updated probability of confidence, which is possibly normalized.

According to one possible more elaborate variant, which is also compatible regardless of the size of the storage circuit and that makes it possible in particular to provide an indication as to the variability of the filter, the filtering processing operation comprises, for each identifier taken into account more than once in the storage circuit, summing of the updated probabilities of confidence, which are possibly normalized, that are associated therewith, formulation of a probability density function for the identifiers that is centered on the identifier having the highest total updated probability of confidence, which is possibly normalized, calculation of the variance of this function, calculation of a ratio between the highest total probability of confidence, which is possibly normalized, and the variance, and comparison of this ratio with a threshold and selection of the filtered detected scene depending on the result of the comparison.

This variant thus makes it possible to ascertain the degree of confidence of the filter and to make a decision as a result.

Thus, if the ratio is lower than the threshold, which may be caused by a large variance, the degree of confidence is low, and it may then be decided to deliver either the scene that effectively has the highest total updated probability of confidence, but while assigning it an item of information characterizing it as ‘uncertain’, or the previous filtered detected scene in terms of time, as detected scene at the output of the filter.

If, by contrast, the ratio is higher than or equal to this threshold, which may be caused by a small variance, the degree of confidence is high, and it may then be decided to deliver the scene that effectively has the highest total updated probability of confidence, which is possibly normalized, as detected scene at the output of the filter.

According to another aspect, there is also proposed a device comprising a detector configured to detect scenes from among a set of possible reference scenes at successive instants of detection using at least one classification algorithm, each new current detected scene being assigned an initial probability of confidence. A processor is configured to update the initial probability of confidence depending on a first probability of transition from a previously detected scene to the new current detected scene. A filter is configured to perform a filtering processing operation on the basis of at least the updated probability of confidence associated with each new current detected scene and to successively deliver filtered detected scenes.

According to one embodiment, the processor is configured to update the initial probability of confidence associated with the new current detected scene by multiplying the initial probability of confidence by the first probability of transition.

According to one embodiment, the processor is configured to normalize the updated probability of confidence associated with the new current detected scene.

According to one embodiment, each transition from a first scene from among the set of possible reference scenes to a second scene from among the set of possible reference scenes is assigned a first probability of transition having an arbitrary or updated value.

According to one embodiment, the processor is configured to update the first probability of transition if, during a given time interval, at least one transition from the first scene to the second scene is performed, and this updating comprises calculation of a second probability of transition for each transition from the first scene to each of the possible second scenes from among the set of possible reference scenes.

According to one embodiment, the processor is configured to update the first probability of transition by increasing the value thereof by a set value if the second probability of transition is higher than the first probability of transition.

According to one embodiment, the processor is configured to update the first probability of transition by reducing the value thereof by a set value if the second probability of transition is lower than the first probability of transition.

According to one embodiment, the processor is configured to update each first probability of transition liable to be updated using a differentiable optimization algorithm.

According to one embodiment, the classification algorithm is configured to deliver the probability of confidence associated with the new current detected scene.

According to one embodiment, if the classification algorithm is not configured to deliver the probability of confidence associated with the new current detected scene, a probability of confidence having an arbitrary value is assigned to the new current detected scene.

According to one embodiment, each reference scene is assigned an identifier, and the filter is configured to perform a filtering processing operation on the basis of the identifier of each new current detected scene and of the updated probability of confidence associated with each new current detected scene.

The device may be for example, a cellular mobile telephone or a digital tablet, or any type of smart object, in particular a smart watch, that is or is not connected to the Internet.

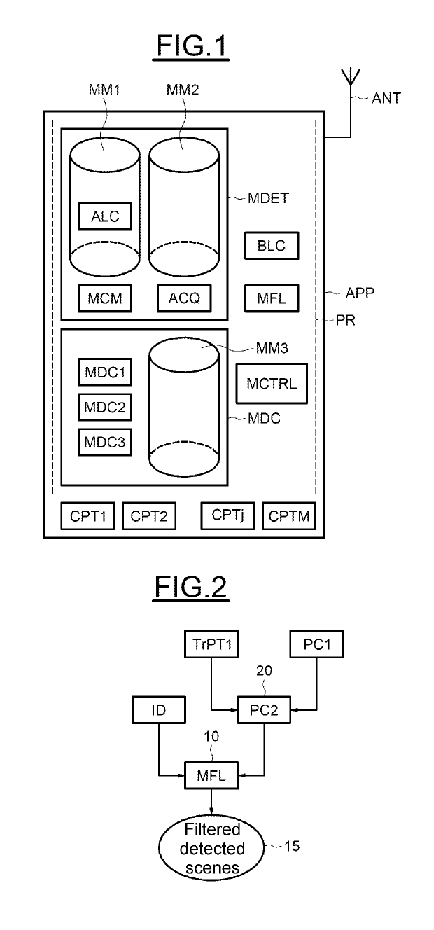

In FIG. 1, the reference APP denotes an electronic device that will be considered, in this non-limiting example, to be a wireless communication device equipped with an antenna ANT. This device may be a cellular mobile telephone, such as a smartphone, or else a digital tablet. Although the invention is able to be applied to any type of device and to any type of scene, mention will now more specifically be made of wireless communication devices.

The device APP in this case includes a plurality of measurement sensors CPT1-CPTj, j=1 to M.

By way of indication, the sensors CPTj may be chosen from the group formed by an accelerometer, a gyroscope, a magnetometer, an audio sensor such as a microphone, a barometer, a proximity sensor or an optical sensor.

Of course, the device may be equipped with a plurality of accelerometers and/or with a plurality of gyroscopes and/or a plurality of magnetometers and/or with a plurality of audio sensors and/or with a barometer, and/or with one or more proximity sensors, and/or with one or more optical sensors.

The audio sensors are useful environment descriptors. Specifically, if the device is not moving, then the audio sensor may be helpful in for detecting the nature of this environment. Of course, depending on the applications, it is possible to use either environmental sensors of accelerometer or even gyroscope or magnetometer type, or audio sensors, or even a combination of these two types of sensors, or else other types of sensors, such as non-inertial sensors of temperature, heat and brightness sensor type.

These environmental measurement sensors may, in particular in a multimodal approach, form, in combination with a conventional discrimination algorithm ALC, for example, of decision tree type and intended to work for example, on filtered crude data originating from these sensors, a detector MDET that is thus able for example, to detect whether the device APP is situated in one environment or another (restaurant, moving vehicle, etc.) or whether the carrier of this device (for example, a smart watch) is performing a specific activity (walking, running, cycling, etc.).

It is now assumed, by way of non-limiting example, that all of the environmental sensors CPT1-CPTM participate in the detection of the scene and supply data at instants of measurement to the discrimination algorithm ALC so as to make it possible to detect the scene.

As will be seen in more detail hereinafter, controlling the detection of scenes obtained on the basis of a classification algorithm uses a filtering processing operation on identifiers of these scenes and uses updated probabilities of confidence associated with these detected scenes.

This filtering processing operation is implemented in a filter MFL.

A description will now be given of one non-limiting example of a classification algorithm providing an initial probability of confidence for each detected scene. Such an algorithm is described for example, in French patent application no. 1752947 (filed Apr. 5, 2017) and U.S. application Ser. No. 15/936,587 (filed Mar. 27, 2018), and some of the features of the algorithm are recalled here. These applications are incorporated herein by reference.

The discrimination algorithm implemented in software form in the scene detector MDET is in this case a decision tree that has carried out a learning phase on a measurement database of the environmental sensors. Such a decision tree is particularly easy to implement and requires only a few kilobytes of memory and an operating frequency of less than 0.01 MHz.

It is stored in a program memory MM1.

The decision tree ALC acts on a vector of attributes. The tree comprises a series of nodes. Each node is assigned to test an attribute.

Two branches leave a node.

Moreover, the output of the tree includes leaves corresponding to reference scenes that the device APP is supposed to detect.

These reference scenes may be for example, without limitation, ‘BOAT’, ‘PLANE’, ‘VEHICLE’, ‘WALKING’ scenes that are representative for example, of the environment in which the device APP, in this case the telephone, may be located.

The detector MDET also includes an acquisition circuit ACQ that is configured to acquire current values of the attributes on the basis of the measurement data originating from the sensors.

The detector MDET includes a command circuit MCM that is configured to activate the software module ALC with the current values of the attributes so as to take a path within the decision tree and obtain, at the output of the path, one scene from among the set of reference scenes, this obtained scene forming the detected scene.

Moreover, the discrimination algorithm also delivers an initial probability of confidence associated with the detected scene, which will be stored in a memory MM2.

In this respect, the initial probability of confidence associated with the detected scene is formulated following the detection of the detected scene and on the basis of the knowledge of this detected scene, in particular by making an additional journey on the path with the knowledge, at each node, of the detected scene.

Other classification algorithms or classifiers that are different from the decision trees and well known to those skilled in the art exist for detecting scenes. Mention may be made in particular of a neural network algorithm that is known to those skilled in the art and for which reference may be made for example, for all useful purposes, to the work by Martin T. Hagan and Howard B. Demuth entitled Neural Network Design (2nd Edition), 1 Sep. 2014, or else an algorithm known to those skilled in the art under the name GMM (‘Gaussian Mixture Model’), those skilled in the art being able to refer for example, for all useful purposes, to the tutorial slides by Andrew Moore entitled ‘Clustering with Gaussian Mixtures’, available on the website https://www.autonlab.org/tutorials/gmm.html.

These two algorithms are also configured to deliver an initial probability of confidence for each detected scene.

The device APP also includes a processor MDC that is configured to update the initial probability of confidence.

The processor MDC comprises a counter MDC1, the role of which will be detailed below, and an arithmetic logic unit (ALU) MDC2 configured to carry out arithmetic operations and comparisons.

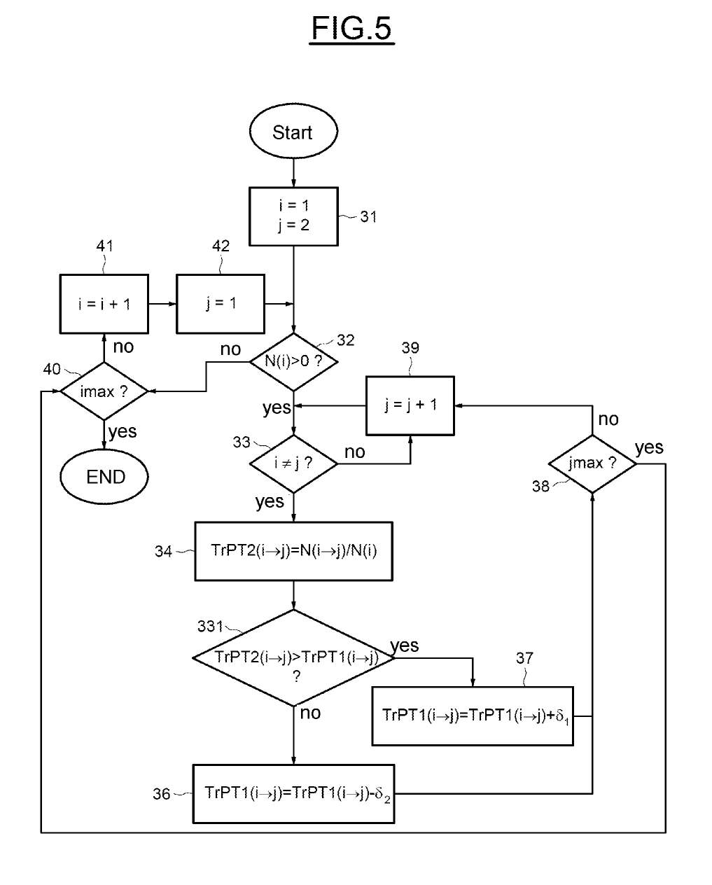

The operations carried out by the arithmetic logic unit MDC2 will be detailed in FIGS. 4 and 5.

The device APP also includes a block BLC able to interact with the detector MDET in order to process the detected scene and transmit the information via the antenna ANT of the device.

Of course, the antenna is optional if the device is not a connected device.

The device also includes a controller MCTRL that is configured to successively activate the detector MDET so as to implement a sequence of scene detection steps that are mutually spaced apart by intervals of time.

These various circuits BLC, MDET, MCTRL, MDC and MFL may for example, be formed at least partly by software modules within a microprocessor PR of the device APP, for example, the microprocessor marketed by STMicroelectronics under the reference STM32.

As illustrated in FIG. 2, the filter MFL is configured to carry out a filtering processing operation 10 using for example, a meta-filter that acts on successive decisions that are delivered by the classification algorithm ALC, regardless of the type thereof and including a meta-classifier.

The filtering processing operation 10 is in this case a sliding temporal filtering processing operation on the detected scenes over a filtering window of size M, on the basis of the identifier of each new current detected scene taken into account in the window and of an updated probability of confidence PC2 associated with this new detected scene. Such a filtering processing operation is described in the abovementioned patent applications FR 1754080 and U.S. Ser. No. 15/924,608.

Of course, the value of M, which defines in particular the latency of the filter, could easily be defined by those skilled in the art depending on the application that is envisaged.

The output of the filtering processing operation successively delivers filtered detected scenes 15.

In this respect, an identifier ID, for example, a number, is assigned to each reference scene.

It is assumed in this case that there are four reference scenes, namely the scenes ‘VEHICLE’, ‘PLANE’, ‘BOAT’ and ‘WALKING’.

The reference scene ‘VEHICLE’ has the identifier 1.

The reference scene ‘PLANE’ has the identifier 2.

The reference scene ‘BOAT’ has the identifier 3, and the reference scene ‘WALKING’ has the identifier 4.

As a result, since each detected scene belongs to one of the reference scenes, the identifier of the current detected scene is an identifier having the same value as one of the reference scenes.

The probability of confidence PC2 associated with the new detected scene is in this case a probability of confidence updated by weighting 20, of the initial probability of confidence PC1 delivered by the discrimination algorithm ALC, by a first probability of transition TrPT1.

This updating is performed by the processor MDC.

If the initial probability of confidence PC1 is not delivered by the discrimination algorithm ALC, it is considered that it has an arbitrary value, set for example, at 100%. In this case, the weighting by the first probability of transition TrPT1 is performed on the probability of confidence having the set value.

The first probability of transition TrPT1 makes it possible to quantify the probability of the user changing from one scene to another.

It is advantageously a parameter to be taken into account in scene detection, as certain transitions from one scene to another are unlikely, or even impossible.

Thus, by taking the first probability of transition TrPT1 into account, the initial probability of confidence PC1 associated with the detected current scene is improved.

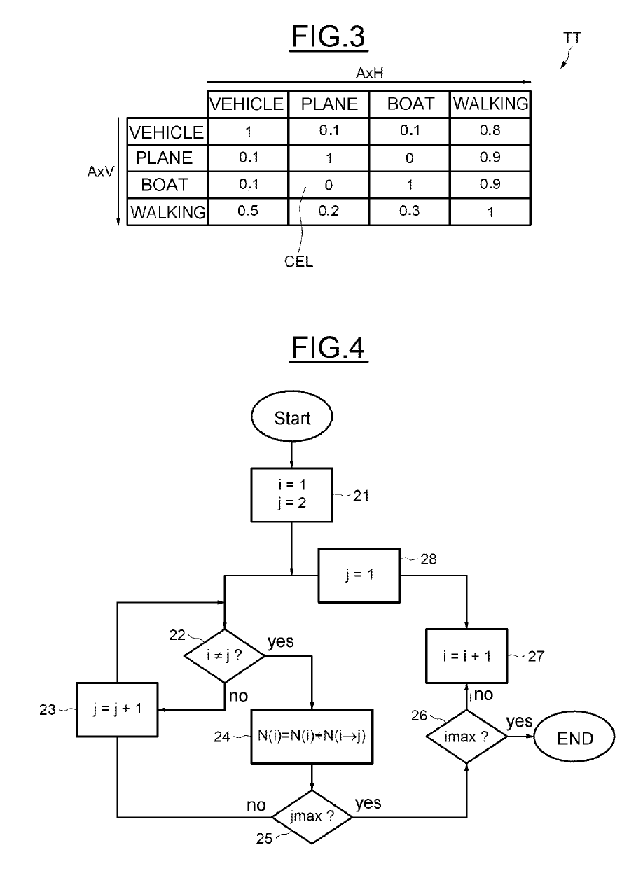

In this respect, as illustrated in FIG. 3, the first probability of transition TrPT1 is able to be extracted from a transition table TT stored in the memory MM3.

The transition table TT is a two-dimensional table. The vertical axis AxV indicates the previously detected scenes, and the horizontal axis AxH indicates the current detected scenes.

Thus, each cell CEL of the transition table TT indicates the probability of transition from a previously detected scene to a current detected scene.

For example, the probability of a transition from the previously detected scene ‘VEHICLE’ to the current detected scene ‘WALKING’ is 0.8, this representing a high probability of transition.

By contrast, the probability of a transition from the previously detected scene ‘VEHICLE’ to ‘BOAT’ is 0.1, this representing a low probability and therefore an unlikely transition for the user who owns the device APP.

This table may, for example, be initially predetermined depending on the applications.

Of course, the habits of the user who owns the device APP change.

It is therefore desirable to update the probability of transition TrPT1, which may have an arbitrary value, so as to guarantee good accuracy of the probability of confidence PC2.

This updating is also performed by the processor MDC.

Reference is now made more particularly to FIGS. 4 and 5 in order to illustrate the various steps of the updating of the first probability of transition TrPT1, by an algorithm comprising two parts.

Before any update, a non-sliding window of observation is activated.

Each instance of transition from a first scene i to a second scene j is accrued using the counter MDC1 for a given time interval, corresponding to N transitions.

These N transitions are advantageously stored in the form of a list in the memory MM3.

Of course, the number N will be chosen by those skilled on the art depending on the corpus of reference scenes.

Once the number N, which corresponds to N transitions, is reached, the instructions of the algorithm that make it possible to update the transition table TT are read.

The first step is a step 21 of initializing the value of a first variable i at 1, corresponding to a first reference scene bearing the identifier 1, and the value of a second variable j at 2, corresponding to a second reference scene bearing the identifier 2.

Step 22 makes it possible to check whether i is indeed different from j. This will be useful for the next instructions of the algorithm.

If i is different from j, the list of the N transitions is run through so as to count, for example, using the counter MDC1, the instances N(i->j) of a transition from the first reference scene bearing the identifier 1 to the second reference scene bearing the identifier 2.

The value of N(i->j) is stored in the memory MM3.

In step 24, the value of N(i), where i is equal to 1, corresponding to the number of transitions from the first reference scene bearing the identifier 1 to each of the possible reference scenes, is incremented by the number of instances N(i->j) of the first transition from the first reference scene bearing the identifier 1 to the second reference scene bearing the identifier 2.

Formula (I) implemented in step 24 is appended.

The value of N(i) is stored in the memory MM3.

Next, step 25 makes it possible to check whether j has reached the maximum value, that is to say a number jmax corresponding to the number of reference scenes, that is to say 4 in this example.

As the maximum value has not yet been reached, in step 23, the value of j is incremented to 3 and the same operations are performed again until the maximum value jmax of j, that is to say 4 in this example, is reached.

In this case, it is checked, in step 26, whether the maximum value imax of i, that is to say 4, is reached. This makes it possible to check that the algorithm has indeed run through all of the possible reference scenes.

If this is not the case, all of the steps described above are reiterated, and the variable j is reinitialized at 1 in step 28.

Thus, once all of the reference scenes have been taken into account, the second part of the algorithm, illustrated in FIG. 5, is executed.

The first step is a step 31 of initializing the value of the first variable i at 1, corresponding to the first reference scene bearing the identifier 1, and the value of the second variable j at 2, corresponding to the second reference scene bearing the identifier 2.

Step 32 checks whether N(i) is greater than 0. In other words, it is checked whether a transition has taken place, during the given interval, from the first reference scene i, where i is equal to 1, to any one of the second reference scenes.

If N(i) is greater than 0, the algorithm moves to the following instruction, shown by step 33, which makes it possible to check whether i is indeed different from j. This will be useful above all for the next instructions of the algorithm.

If i is different from j, the arithmetic logic unit MDC2 calculates, in step 34, a second probability of transition TrPT2(i->j) from the first reference scene i, where i is equal to 1, corresponding to the first reference scene bearing the identifier 1, to a second reference scene j, where j is equal to 2, corresponding to the second reference scene bearing the identifier 2.

This appended calculation (II) is a division of the number of instances N(i->j) of the first transition from the first reference scene bearing the identifier 1 to the second reference scene bearing the identifier 2 by N(i), corresponding to the number of transitions from the first reference scene bearing the identifier 1 to each of the possible reference scenes.

Thus, this second probability of transition TrPT2(i->j) will be compared with the first probability of transition TrPT1(i->j) by the arithmetic logic unit MDC2 in step 331.

Thus, if the second probability of transition TrPT2(i->j) is higher than the first probability of transition TrPT1(i->j), the value of the first probability of transition TrPT1(i->j) is increased by a first set value 61, in step 37 (appended formula III).

The first set value 61 may be for example, between 0.01 and 0.05.

The first probability of transition TrPT1(i->j) is updated and stored in the transition table IT.

Otherwise, the value of the first probability of transition TrPT1(i->j) is reduced by a second set value δ2, in step 36 (appended formula IV).

The second set value δ2 may be for example, between 0.01 and 0.05.

The first probability of transition TrPT1(i->j) is updated and stored in the transition table IT.

Next, step 38 makes it possible to check whether j has reached the maximum value, that is to say the number jmax corresponding to the number of reference scenes, that is to say 4 in this example.

If the maximum value jmax has not yet been reached, in step 39, the value of j is incremented to 3 and the same operations are performed again until the maximum value jmax of j, that is to say 4, is reached.

In this case, it is checked, in step 40, whether the maximum value imax of i, that is to say 4, is reached. This makes it possible to check that the algorithm has indeed run through all of the possible reference scenes.

If this is not the case, all of the steps described above are reiterated, and the variable j is reinitialized at 1.

Thus, once all of the reference scenes have been taken into account, there are no more instructions to be executed.

As a result, any transition between a first scene i from among the set of possible reference scenes to a second scene j from among the set of reference scenes, observed by the non-sliding window of observation during a given interval, makes it possible to update the probability of transition from the first scene i to the second scene j, and thus subsequently improve the probability of confidence delivered by the discrimination algorithm ALC.

Moreover, the invention is not limited to these embodiments and modes of implementation, but encompasses all variants thereof.

Thus, the updating of the probability of transition TrPT(i->j) could be performed by any other algorithm within the scope of those skilled in the art, in particular by a differentiable optimization algorithm implementing formula (V) presented in the appendix.

$$\begin{matrix}Appendix & \\ N ( i ) = {\sum }_{j = 1}^{4} N ( i \to j ) & ( I ) \\ TrPT 1 ( i \to j ) = \frac{N ( i \to j )}{N ( i )} & ( II ) \\ TrPT 1 ( i \to j ) = TrPT 1 ( i \to j ) + {δ}_{1} & ( III ) \\ TrPT 1 ( i \to j ) = TrPT 1 ( i \to j ) - {δ}_{2} & ( IV ) \\ TrPT 1 ( i \to j ) = TrPT 1 ( i \to j ) - δ ( TrPT 1 ( i \to j ) - TrPT 2 ( i \to j ) ) & ( V )\end{matrix}$$

What is claimed is:

1. A method for controlling scene detection by a device from among a set of possible reference scenes, the method comprising:
detecting scenes from among the set of possible reference scenes at successive instants of detection using at least one classification algorithm;
assigning an initial probability of confidence to each new current detected scene;
updating the initial probability of confidence depending on a first probability of transition from a previously detected scene to the new current detected scene; and
performing a filtering processing operation on the current detected scenes based on at least the updated probability of confidence associated with each new current detected scene, an output of the filtering processing operation successively delivering filtered detected scenes.

2. The method according to claim 1, wherein updating the initial probability of confidence associated with the new current detected scene comprises multiplying the initial probability of confidence by the first probability of transition.

3. The method according to claim 1, further comprising normalizing the updated probability of confidence associated with the new current detected scene.

4. The method according to claim 1, wherein the classification algorithm delivers the initial probability of confidence associated with the new current detected scene.

5. The method according to claim 1, wherein, when the classification algorithm does not deliver the initial probability of confidence associated with the new current detected scene, the new current detected scene is assigned an initial probability of confidence having an arbitrary value.

6. The method according to claim 1, further comprising assigning an identifier to each reference scene, the filtering processing operation on the current detected scenes being carried out based on the identifier of each new current detected scene and of the updated probability of confidence associated with this new current detected scene.

7. A method for controlling scene detection by a device from among a set of possible reference scenes, the method comprising:
detecting scenes from among the set of possible reference scenes at successive instants of detection using at least one classification algorithm;
assigning an initial probability of confidence to each new current detected scene;
updating the initial probability of confidence depending on a first probability of transition from a previously detected scene to the new current detected scene;
performing a filtering processing operation on the current detected scenes based on at least the updated probability of confidence associated with each new current detected scene, an output of the filtering processing operation successively delivering filtered detected scenes; and
assigning a first probability of transition to each transition from a first scene from among the set of possible reference scenes to a second scene from among the set of possible reference scenes, the first probability of transition having an arbitrary or updated value.

8. The method according to claim 7, further comprising updating the first probability of transition when, during a given time interval, a transition from the first scene to the second scene is performed.

9. The method according to claim 8, wherein the updating comprises calculating a second probability of transition for each transition from the first scene to each of the possible second scenes from among the set of possible reference scenes.

10. The method according to claim 9, wherein updating the first probability of transition comprises increasing the value thereof by a first set value when the second probability of transition is higher than the first probability of transition; and
wherein updating the first probability of transition comprises reducing the value thereof by a second set value when the second probability of transition is lower than the first probability of transition.

11. The method according to claim 8, wherein updating the first probability of transition comprises updating the first probability of transition using a differentiable optimization algorithm.

12. A device comprising:
a detector configured to detect scenes from among a set of possible reference scenes at successive instants of detection using a classification algorithm, each new current detected scene being assigned an initial probability of confidence;
a processor configured to update the initial probability of confidence depending on a first probability of transition from a previously detected scene to the new current detected scene; and
a filter configured to perform a filtering processing operation based on at least the updated probability of confidence associated with each new current detected scene and to successively deliver filtered detected scenes.

13. The device according to claim 12, wherein the processor is configured to update the initial probability of confidence associated with the new current detected scene by multiplying the initial probability of confidence by the first probability of transition.

14. The device according to claim 12, wherein the processor is configured to normalize the updated probability of confidence associated with the new current detected scene.

15. The device according to claim 12, wherein each transition from a first scene from among the set of possible reference scenes to a second scene from among the set of possible reference scenes is assigned a first probability of transition having an arbitrary or updated value.

16. The device according to claim 15, wherein the processor is configured to update the first probability of transition when, during a given time interval, a transition from the first scene to the second scene is performed, the processor being configured to update using a calculation of a second probability of transition for each transition from the first scene to each of the possible second scenes from among the set of possible reference scenes.

17. The device according to claim 16, wherein the processor is configured to update the first probability of transition by increasing the value thereof by a first set value when the second probability of transition is higher than the first probability of transition.

18. The device according to claim 16, wherein the processor is configured to update the first probability of transition by reducing the value thereof by a second set value when the second probability of transition is lower than the first probability of transition.

19. The device according to claim 15, wherein the processor is configured to update each first probability of transition to be updated using a differentiable optimization algorithm.

20. The device according to claim 12, wherein the classification algorithm is configured to deliver the initial probability of confidence associated with the new current detected scene.

21. The device according to claim 12, wherein, when the classification algorithm is not configured to deliver the initial probability of confidence associated with the new current detected scene, an initial probability of confidence having an arbitrary value is assigned to the new current detected scene.

22. The device according to claim 12, wherein, with each reference scene being assigned an identifier, the filter is configured to perform a filtering processing operation based on the identifier of each new current detected scene and of the updated probability of confidence associated with each new current detected scene.

23. The device according to claim 12, wherein the device is a cellular mobile telephone or a digital tablet or a smart watch.
